(19) United States
(12) Patent Application Publication
(10) Pub. No.: US 2013/0041938 A1
(43) Pub. Date: Feb. 14, 2013

(54) Dynamic Mobile Interaction Using Customized Interfaces

(71) Applicant: Jie LIN, San Francisco, CA (US)

(72) Inventor: Jie LIN, San Francisco, CA (US)

(21) Appl. No.: 13/569,181

(22) Filed: Aug. 8, 2012

Related U.S. Application Data
(60) Provisional application No. 61/574,911, filed on Aug. 11, 2011.

(51) Int. Cl. G06F 15/16

(52) U.S. Cl. 709/203

(57) ABSTRACT

A mobile device (or app on the mobile device) can be paired with an application executing on a computing device external to the mobile device. The pairing can be based at least in part upon a unique ID assigned to the application on the computing device by a network server. For example, the network server can assign the application on the computing device a unique ID and the application can provide a machine-readable code corresponding to the unique ID. The (app on the) mobile device can read/scan the machine-readable code to become paired with the application. Subsequent to the pairing, (the app on) the mobile device and (the application on) the external computing device can interact dynamically via a network (e.g., communicate in real-time via the Internet). In some embodiments, the network server can facilitate the dynamic interaction between the mobile device and the external computing device via the network.

### CROSS-REFERENCE TO RELATED APPLICATIONS

This application claims the benefit of U.S. provisional application Ser. No. 61/574,911, filed Aug. 11, 2011, entitled “Web-Based Application Controlled By A Mobile Device,” which is hereby incorporated herein in its entirety by reference.

### BACKGROUND

Mobile computing devices (i.e., mobile devices) are becoming more popular and are being used increasingly for various tasks. People commonly use mobile devices to browse the Internet, play games, or communicate with one another. In addition to mobile computing devices such as smartphones and tablets, people also use other computing devices, such as desktop computers, laptop/notebook computers, and televisions (e.g., smart televisions), that are external to the mobile devices. However, people generally engage in using their computing devices and mobile devices separately. For example, a person might be playing a video game on the computing device and checking his/her email on the mobile device. In another example, a person might be writing using a word processing application on the computing device and playing a game app on the mobile device. As such, it would be beneficial to have an efficient and convenient approach to provide for interaction between a mobile device and a computing device external to the mobile device.

### BRIEF DESCRIPTION OF THE DRAWINGS

Various embodiments in accordance with the present disclosure will be described with reference to the drawings, in which:

FIG. 1 illustrates an example environment in which aspects of the various embodiments can be utilized;

FIG. 2 illustrates an example system embodiment for dynamic mobile interaction using customized interfaces;

FIG. 3 illustrates an example system embodiment for dynamic mobile interaction using customized interfaces;

FIG. 4A illustrates an example application of dynamic mobile interaction using customized interfaces;

FIG. 4B illustrates an example application of dynamic mobile interaction using customized interfaces;

FIG. 4C illustrates an example application of dynamic mobile interaction using customized interfaces;

FIG. 4D illustrates an example application of dynamic mobile interaction using customized interfaces;

FIG. 5 illustrates an example method embodiment for dynamic mobile interaction using customized interfaces;

FIG. 6 illustrates an example device that can be used to implement aspects of the various embodiments;

FIG. 7 illustrates example components of a client device such as that illustrated in FIG. 6; and

FIG. 8 illustrates an environment in which various embodiments can be implemented.

### SUMMARY

Systems and methods in accordance with various embodiments of the present disclosure overcome one or more of the above-referenced and other deficiencies in conventional approaches to computer operation. Various embodiments attempt to provide for dynamic mobile interaction using customized interfaces. In particular, various embodiments can allow a mobile computing device (i.e., mobile device) to dynamically interact with a computing device external to the mobile device using customized interfaces.

In at least some embodiments, a computing device and/or an application, such as a web browser, running on the computing device can be assigned a unique identification (ID) by a network server/service (e.g., deMobo.com). A mobile device external to the computing device can be paired with the computing device and/or application running on the computing device based at least in part upon the assigned unique ID. For example, (the application on) the computing device can present a machine-readable code, generated based at least in part upon the unique ID. (In some embodiments, the machine-readable code can comprise at least one of a QR code, a Microsoft TAG, a matrix bar code, a wireless near-field communication signal, a RFID signal, a Bluetooth signal, a short-range wireless signal, a uniquely identifiable image, a uniquely identifiable biometric code, or an audio tag.) The mobile device can scan/read the machine-readable code and become paired with (the application on) the computing device. In some embodiments, the pairing can be saved such that it needs to occur only once. For example, if a mobile device has previously established a pairing with (the application on) the computing device, then the pairing process need not occur again. In other words, once the mobile device and (the application on) the computing device have been paired once, they can automatically save the pairing and are no longer unpaired (i.e., no longer previously unpaired).

In some embodiments, subsequent to the pairing between the mobile device and the computing device external to the mobile device, the mobile device and computing device can communicate via a network, such as the Internet. For example, an app (e.g., game, web browser, etc.) on the mobile device can communicate with an application (e.g., game, web browser, etc.) on the computing device via the Internet, intranet, etc. For example, a web browser application on the computing device can provide (e.g., render) a website, while a web browser app on the mobile device can provide a mobile version of a website, wherein the mobile version is configured to interact dynamically (e.g., manipulate, communicate, transfer, share data in real-time) with the website provided by the computing device.

In some embodiments, the dynamic communication between the mobile device and the computing device external to the mobile device can be facilitated by the network server/service (e.g., deMobo.com). In some embodiments, the dynamic interaction between the mobile device and the computing device can be based at least in part upon communicating among (the app running on) the mobile device, (the application running on) the computing device, the network server, a website server hosting the website rendered by (the application running on) the computing device, and a mobile server providing data associated with (the app running on) the mobile device.

In some embodiments, (an app on) the mobile device can establish a connection for communicating with a network server. The (app on the) mobile device can pair with a first web-connected application running on a computing device external to the mobile device if the mobile device and the first web-connected application have been previously unpaired, wherein the first web-connected application is communicatively connected to the network server. The (app on the) mobile device can receive an instruction from the first paired web-connected application to retrieve a first interface for interacting with the first paired web-connected application, wherein the first interface is retrieved from a plurality of interfaces, each interface in the plurality being customized to interact with a different web-connected application. The (app on the) mobile device can automatically present the retrieved first interface, wherein the first interface is customized to interact with the first paired web-connected application. The (app on the) mobile device can initiate one or more inputs for interacting with the first paired web-connected application. The (app on the) mobile device can communicate with the first paired web-connected application via the established connection with the network server to dynamically manipulate data associated with the first paired web-connected application based at least in part upon utilizing the one or more inputs.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### DETAILED DESCRIPTION

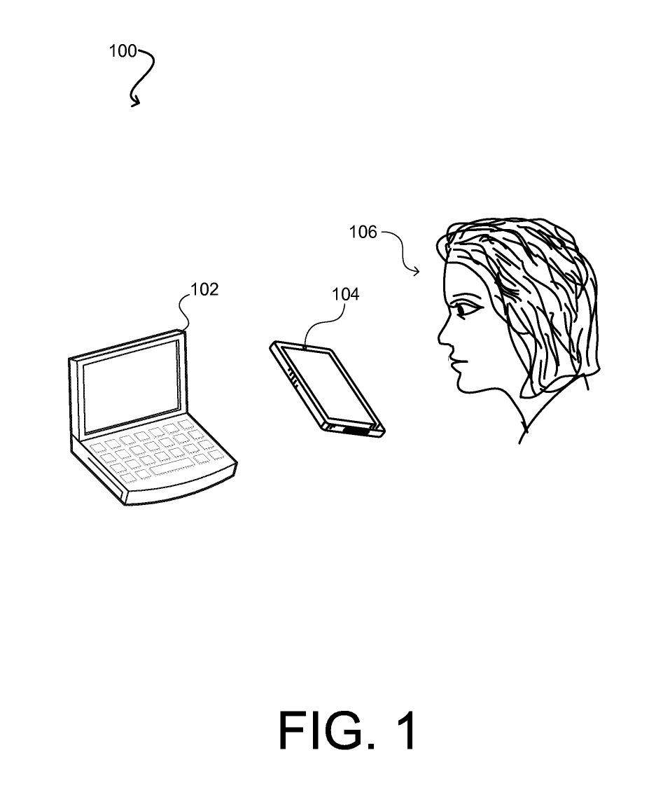

FIG. 1 illustrates an example environment 100 in which aspects of the various embodiments can be utilized. In some embodiments, the example environment 100 can include a mobile computing device (i.e., mobile device) 104 and a computing device 102 external to the mobile device 104 (i.e., external computing device 102). A user 106 of the mobile device 104 can also be a user 106 of the external computing device 102, and vice versa. In other words, the user 106 can use both the mobile device 104 and the computing device 102 external to the mobile device 104. In some embodiments, one user can use the mobile device 104 and another can use the external computing device 102.

In some embodiments, each of the mobile device 104 and the external computing device 102 can be used by the user 106 (or one or more users) to connect to a network, such as the Internet (i.e., World Wide Web), an intranet, etc. For example, the user 106 can use each of his/her external computing device 102 and his/her mobile device 104 to connect to WiFi and/or a cellular data network to view a website. A website server hosting the website can send data about the website to the external computing device 102 such that an application (e.g., web browser) on the computing device 102 can render the website properly. In some embodiments, the website server can send data about the website to the mobile device 104 such that a browsing or other application on the mobile device 104 can render the website in a fashion similar to how the external computing device 102 would render the website (e.g., full website, full version of the website, etc.). In some embodiments, the website server can send data about the website to the mobile device 104 such that the browsing or other application on the mobile device 104 renders the website in a manner different (e.g., mobile website, mobile/simplified version of the website, etc.) from how the website would be rendered on the external computing device 102.

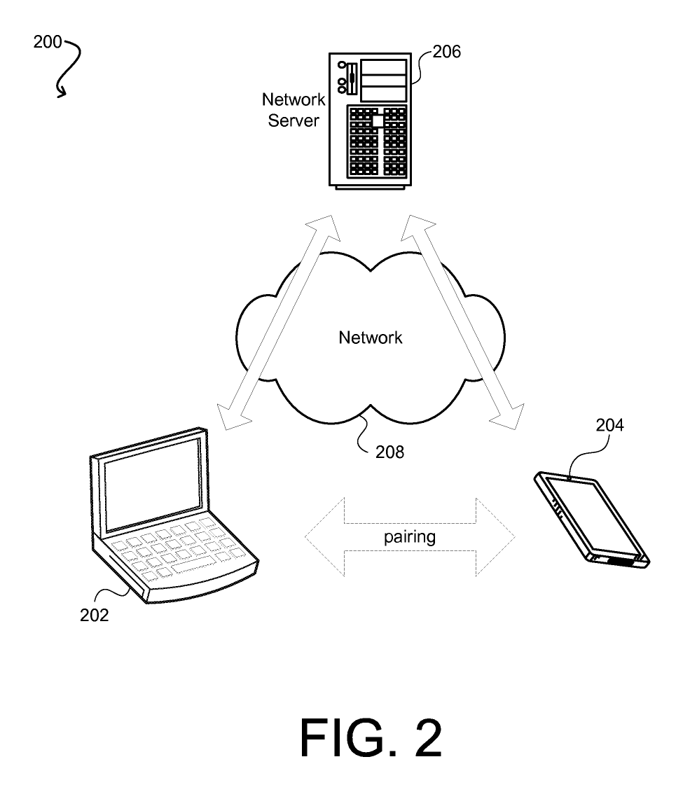

FIG. 2 illustrates an example system embodiment for dynamic mobile interaction using customized interfaces. The example system embodiment 200 can comprise a mobile computing device (i.e., mobile device) 204, an external computing device (i.e., computing device external to the mobile device) 202, and a network server/service 206 (e.g., a server associated with deMobo.com). The external computing device 102 can execute/run one or more applications (e.g., web browser, web-connected application, system/file browsing application, game, media playing application, wording processing application, etc.). For example, an application on the external computing device 102 can be a web browser used for rendering and/or viewing a website (e.g., webpage, web application, etc.). Moreover, the application (e.g., web browser, etc.) can be utilized for communicating with the network server 206.

The mobile device 204 can also include one or more applications (e.g., web browser, web-connected application, game, app, etc.). An application on the mobile device 204 can be used, for example, to render and/or view a website. The application on the mobile device 204 can also be used for communicating with the network server 206.

The network server 206 can be any type of server communicatively connected to a network 208, such as the Internet, intranet, etc. The network server 206 can be configured to communicate to the external computing device 202 and/or to the mobile device 204, for example, via the network 208 to which it is connected. In some embodiments, the network server 206 can reside on a device (e.g., web server, network router/hub, etc.) remote from the external computing device 202 and the mobile device 204, as shown in FIG. 2. However, although the network server 206 is shown in the example system embodiment 200 to be remote from the external computing device 202 and shown to communicate with the external computing device 202 via the network 208, it is also contemplated that, in some embodiments, the network server 206 can reside on/with the external computing device 202, such that the server 206 and the external device 202 can communicate with each other without going through the network 208.

In the example system embodiment 200, there can be a pairing between the mobile device 204 (or an app running on the mobile device 204) and (an application running on) the external computing device 202. In some embodiments, the network server 206 can facilitate the pairing between the mobile device 204 and the application on the external computing device 202. For example, a web browser (i.e., application) on the external computing device 202 can be used to access the network server 206 (e.g., deMobo.com), such that the network server 206 can provide a readable/scannable QR code (or other machine-readable code, NFC tag, audio tag, etc.) to be presented via the web browser. In some embodiments, the scannable QR code can be provided by the network server 206 to include a unique identification (ID) key for the web browser. In other words, the network server 206 can assign a unique ID to the web browser (on the external computing device 202) and provide a scannable QR code generated based on the unique ID for the web browser.

In some embodiments, each computing device (or each browser on a computing device) can be assigned a unique ID. For example, an application programming interface (API) of the network server 206 (e.g., an API of deMobo) can assign such unique IDs for browsers/computing devices.

Continuing with the example, the mobile device 204 can execute an app (e.g., deMobo app), which can enable the scanning of the QR code presented via the web browser running on the external device 202. Upon scanning the QR code, the mobile device 204 (e.g., the app running on the mobile device 204) and the web browser (i.e., application) running on the external computing device 202 can communicate and exchange information with each other via the network server 206 and become paired (assuming the app on the mobile device and the application on the external computing device had never been paired before). In some embodiments, the pairing can be remembered such that the mobile device 204 need not be paired again with the web browser/application on the external computing device 202.

In some embodiments, a website external to the network server 206 can facilitate the pairing between the application on the external device 202 and the app/mobile device 204. In some embodiments, a website (e.g., ExampleWebsiteA.com) external to the network server 206 can collaborate with the network server 206 (e.g., deMobo.com) to enable the pairing. For example, a website (i.e., external website) external to the network server 206 can work with the network server 206, such that the network server 206 provides the scannable QR code to the external website for presentation on the external website. For example, a web browser on the external computing device 202 can access the external website, which presents a QR code generated at least in part based on the network server 206; an app on the mobile device 204 can scan/read the QR code and become paired with the web browser and/or the external website.

In some embodiments, instead of or in addition to a machine readable code (e.g., QR code, NFC tag, audio tag, etc.), a password or a sequence of characters can be presented on the external computing device 202 (e.g., via an application on the external device 202) to be inputted on the mobile device 204 (e.g., an app on the mobile device 204) to establish a pairing. For example, the network server 206 can provide a unique sequence of characters to be presented via a web browser on the external device 202. When the unique sequence of characters is inputted via an app on the mobile device 204, the app and/or the mobile device 204 can be paired with the web browser on the external device 202.

Furthermore, the network server 206 can facilitate communication between the external computing device 202 and the mobile device 204. The network server 206 can facilitate the exchange of information between an application (e.g., web browser) running on the external device 202 and an app (e.g., mobile web browser) running on the mobile device 204. The mobile device 204 (or the app on the mobile device 204) can transmit instructions via the network server 206 to dynamically manipulate the application on the external computing device 202, and vice versa. For example, based on user input via the mobile device 204, the app on the mobile device 204 can manipulate data on the web browser (and/or a website rendered/viewed by the web browser) on the external device 202 to be altered in real-time. Likewise, data on the app of the mobile device 204 can be manipulated in real-time by the web browser (and/or by the website rendered/viewed by the web browser) via the network server 206.

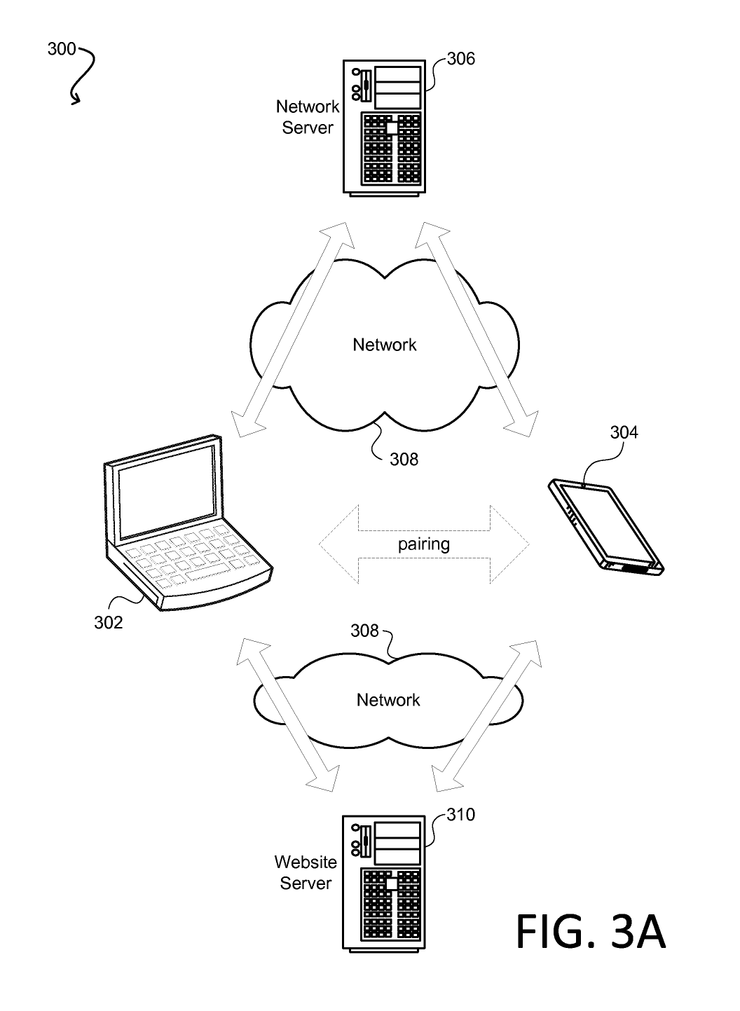

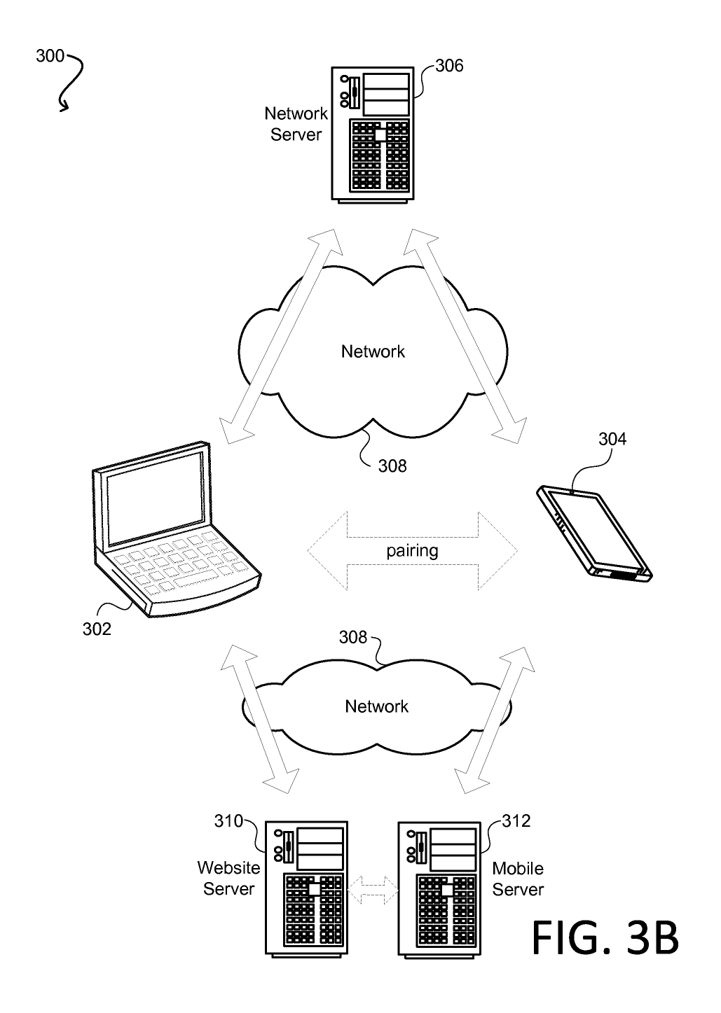

FIG. 3A illustrates an example system embodiment for dynamic mobile interaction using customized interfaces. The example system embodiment 300 can comprise an external computing device 302, a mobile device 304, a network server 306, and a website server 310. The website server 310 can be any type of server for serving and/or hosting websites. The website server 310 can communicate with the external computing device 302 and the mobile device 304 via the network 308. For example, the website server 310 can provide data to the external device 302 such that an application (e.g., web browser) on the external device 302 can process/utilize the data (e.g., render/view a website represented by the data). Likewise, the website server 310 can provide data to the mobile device 304 to be processed/utilized (e.g., an app on the mobile device 304 can render/view a website represented by the data). In some embodiments, the website server 310 can provide data representing a website in a similar fashion (e.g., full version of the website) for both the external computing device 302 and the mobile device 304. In some embodiments, the website server 310 can provide (data representing) the website differently for each of the external computing device 302 and the mobile device 304 (e.g., a full version of the website for the external device 302 and a mobile version for the mobile device 304). In some embodiments, for example, the website server 310 can be split into two servers, the first server (i.e., website server) for serving external computing devices and the second server for serving mobile devices, as shown in FIG. 3B.

The website server 310 can also allow for the exchange of information between (an application running on) the external computing device 302 and (an app running on) the mobile device 304. For example, the website server 310 can facilitate user input via the app/mobile device 304 to dynamically manipulate/alter the website (hosted by the website server 310 and) rendered by the web browser on the external computing device 302, and vice versa (e.g., the website server 310 can dynamically manipulate/alter the app on the mobile device 304 in response to commands/instructions from the website).

FIG. 3B illustrates an example system embodiment for dynamic mobile interaction using customized interfaces. FIG. 3B illustrates the example system embodiment 300 of FIG. 3A further comprising a mobile server 312. As previously discussed, the website server 310 of FIG. 3A can provide (data representing) a website differently for each of the external computing device 302 and the mobile device 304 (e.g., a full version of the website for the external device 302 and a mobile version of the website for the mobile device 304). In some embodiments, the website server 310 of FIG. 3A can be split into two or more servers, as shown in FIG. 3B. The first server 310 (i.e., website server) can be for serving a full version of a website to be viewed on devices such as the external device 302. The second server 312 (i.e., mobile server) can be for serving mobile devices, such as mobile device 304. In some embodiments, the website server 310 and the mobile server 312 can optionally communicate and/or collaborate with each other, which can enable the mobile device 304 and external computing device 302 to dynamically manipulate (e.g., alter) each other's data. In some embodiments, the mobile server 312 can be provided by a party different and/or separate from the party that provides the website server 310. For example, the website server 310 can be provided by Pandora.com whereas the mobile server 312 can be provided by Pandorafans.com/mobile.

In some embodiments, the browser (i.e., application) on the external computing device 302 can be modified/altered (e.g., via an installed add-on, plug-in, extension, etc.) to work with the network server 306 (e.g., deMobo) and/or the website server 310. For example, if the website server 310 is not configured to work with the application on the mobile device 304, then the application on the mobile device 304 can communicate with the external computing device's browser which can have an installed add-on (e.g., plug-in, extension, etc.) to work with the mobile server 312; then the mobile server 312 can communicate with the website server 310 via the installed add-on for the external computing device's browser. Accordingly, in some embodiments, the application on the mobile device 304 can communicate with the website server 310 via the add-on (e.g., plug-in, extension, etc.) of the browser on the external computing device 302 and via the mobile server 312.

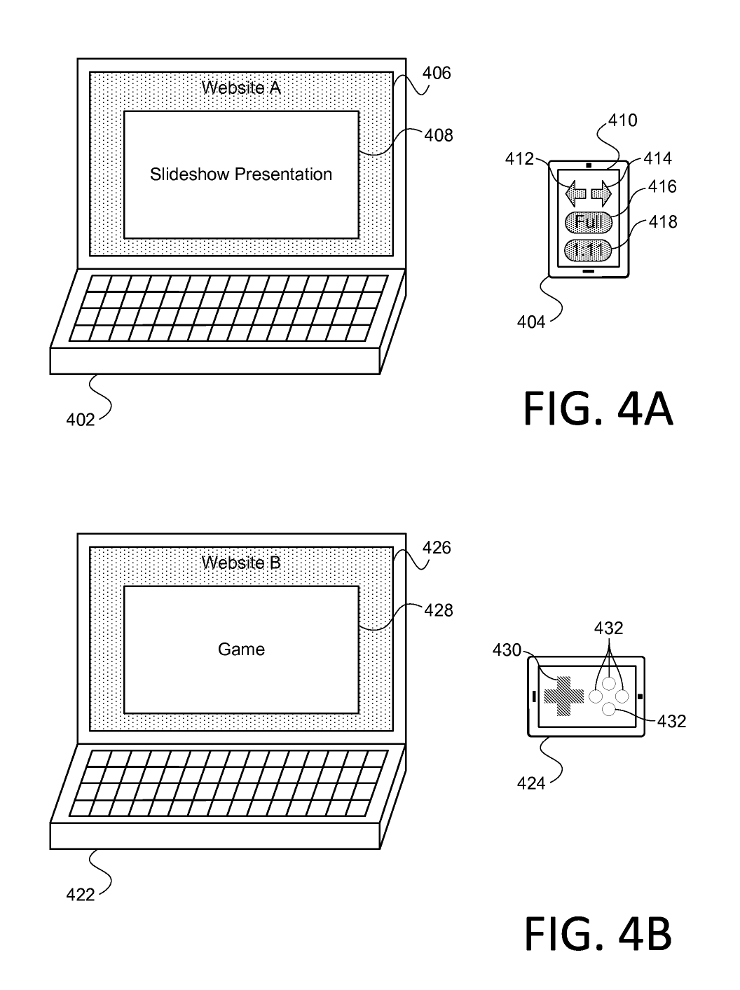

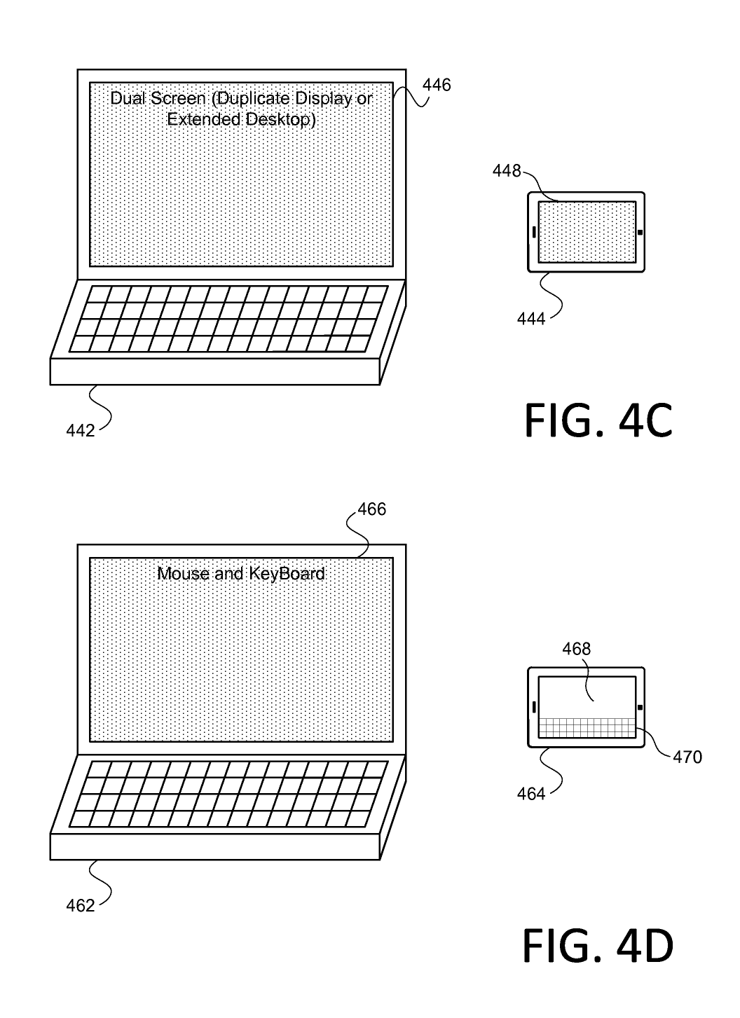

FIG. 4A illustrates an example application of dynamic mobile interaction using customized interfaces. The non-limiting example application of FIG. 4A can include an external computing device 402 and a mobile device 404. The external device 402 can be running/executing an application (e.g., a web browser, web-connected application, etc.). The application can provide/present content (e.g., the web browser can render/view a website 406, such as Website A). The content can be for performing one or more tasks (e.g., the website 406 can run a program 408, such as web application, script, applet, etc.). In this example, Website A 406 provides an application for making a slide show presentation 408.

The mobile device 404 of FIG. 4A can execute/run an app 410. The app 410 (i.e., mobile app) on the mobile device 404 can be paired with the application (or content made available by the application) on the external device 402 (e.g., the mobile app 410 can be paired with the web browser and/or website 406). Upon being paired, the mobile app 410 can retrieve an interface customized for the website 406 and can dynamically manipulate (e.g., alter) data on the web browser/website 406. For example, as shown in FIG. 4A, the mobile app 410 can retrieve a slideshow remote control interface customized for the slideshow website 406 and can cause the slide show presentation 408 being displayed on the web browser of the external computing device 402 to move to the previous slide via button 412, move to the next slide via button 414, switch into a “full screen” mode via button 416, etc. The mobile app 410 can also provide other features, such as a stopwatch/timer 418. In some embodiments, the mobile app 410 can allow input via an accelerometer, gyroscope, camera, microphone (e.g., for speech), touchscreen, etc. on the mobile device 404 to further dynamically alter the data on the web browser/website 406.

In some embodiments, the mobile app 410 can be a web browser on the mobile device 404. When visiting Website A using the web browser of the mobile device 410, Website A can provide a mobile version of the Website A, which can include the user interface (e.g., buttons 412, 414, 416, and other features such as 418) customized to work in conjunction with Website A on the external computing device for operating the example slide show presentation as illustrated in FIG. 4A.

FIG. 4B illustrates an example application of dynamic mobile interaction using customized interfaces. In the non-limiting example application of FIG. 4B, there can be an external computing device 422 and a mobile device 424. The external computing device 422 can be running an application, such as a web browser. The web browser can render/view a website, such as Website B 426. The website (e.g., Website B) 426 can provide a web application, such as a game 428.

Upon pairing the mobile device 424 with the web browser (and/or Website B), the mobile device 424 can retrieve an interface (e.g., a mobile version of Website B) customized for dynamically interacting with Website B 426. As such, the mobile device 424 be used to operate (e.g., play) the game 428 provided by Website B 426. For example, the interface retrieved by (the app on) the mobile device 424 can be a graphical user interface including a directional keypad 430, one or more buttons 432, and other ways to submit input (e.g., fingertip(s) gesture/motion recognition via a touchscreen, voice recognition via a microphone, tilt/rotate recognition via a gyroscope, device gesture/movement via an accelerometer, etc.). When input is submitted via the mobile device 424, the game presented on the web browser of the external computing device 422 can be dynamically altered by, and can respond dynamically to, the input from the mobile device 424.

FIG. 4C illustrates an example application of dynamic mobile interaction using customized interfaces. In the example application of FIG. 4G, there can be a dual screen set up using an external computing device 442 and a mobile device 444. For example, the external computing device 442 can execute an application that provides a first screen 446, while the mobile device 444 (subsequent to pairing with the external device 442) can retrieve an interface customized to interact with the application on the external computing device 442, wherein the interface provides a second screen 448.

In some embodiments, the display screens of the external device 442 and the mobile device 444 can be duplicates of each other; in other words, what is shown on the display screen 446 of the external device 442 can be the same as what is shown on the display screen 448 of the mobile device 444. In some embodiments, the set up can be an “extended desktop” in which one screen is an extension of the other, and the other screen is also an extension of the former screen. With the “extended desktop” set up, graphical objects (e.g., icons) representing files and/or windows for applications can be moved from the display screen 446 of the external device 442 to that 448 of the mobile device 444, and vice versa (e.g., “drag and drop,” tapping/holding an icon and flicking it across one screen to another, etc.). In addition, windows for applications can be stretched/resized such that a portion of one window is viewed on one screen while another portion of the window is viewed on the other screen.

FIG. 4D illustrates an example application of dynamic mobile interaction using customized interfaces. In this example, a mobile device 464 can be used as an input device, such as a mouse and/or a keyboard, for operating/controlling the external computing device 462. For example, the external device 462 can execute an application for remote input (e.g., keyboard, mouse, etc) and the mobile device 464 (after being paired) can retrieve a keyboard/mouse interface customized to interact and work in conjunction with the external computing device's application for remote input. The application running on the external device 462 can be capable of communicating with (the interface provided by the app of) the mobile device 464, and vice versa. Input for operating/controlling the external computing device 462 can be provided/initiated using the mobile device 464. For example, a touchscreen of the mobile device 464 can provide for a touch-sensitive mouse pad, one or more buttons on the mobile device 464 (including one or more buttons provided via the touchscreen of the mobile device 464) can provide for one or more keys (e.g., keyboard), and an accelerometer/gyroscope can be utilized to provide input to operate/control the external device 462 as well.

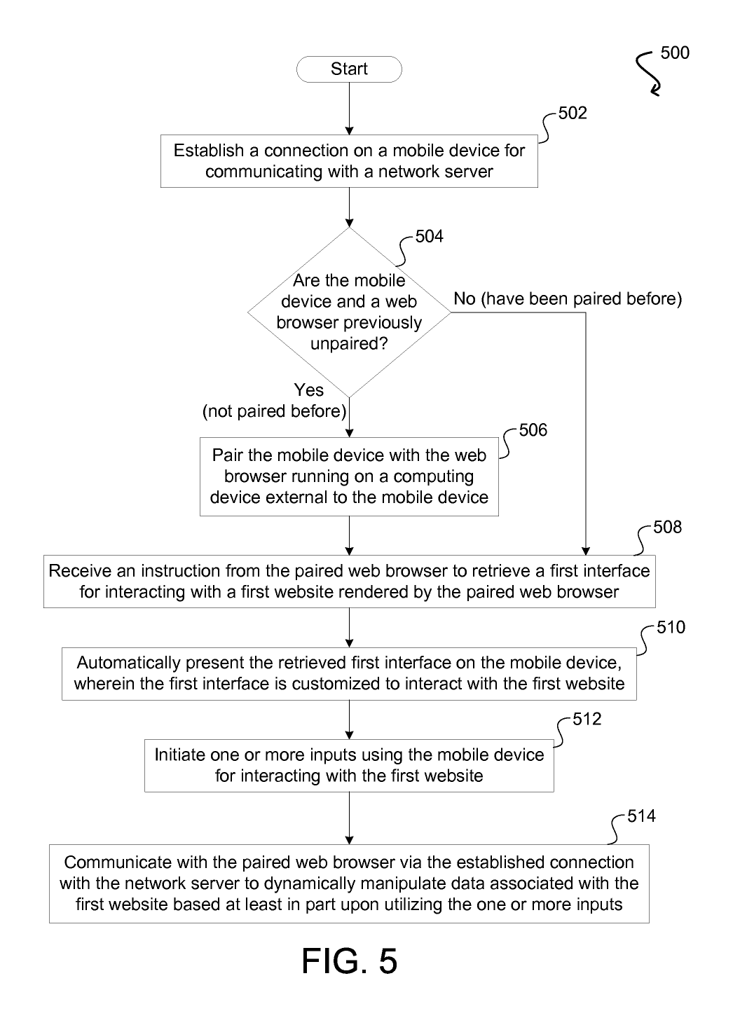

FIG. 5 illustrates an example method embodiment for dynamic mobile interaction using customized interfaces. It should be understood that there can be additional, fewer, or alternative steps performed in similar or alternative orders, or in parallel, within the scope of the various embodiments unless otherwise stated. The example method embodiment 500 can establish a connection on a mobile device for communicating with a network server, at step 502. At step 504, the example embodiment 500 can check if (an app on) the mobile device and a web browser running on a computing device external to the mobile device have been previously unpaired. If they have not been previous paired (or if data regarding a previous pairing was not saved), then the method 500 can pair (the app on) the mobile device with the web browser running on a computing device external to the mobile device, at step 506. Otherwise if they have been paired before (and the previous pairing was saved), then the method 500 need not pair them again. In some embodiments, the web browser is communicatively connected to the network server.

At step 508, the example method 500 can receive an instruction from the paired web browser to retrieve a first interface for interacting with a first website rendered by the paired web browser. The first interface can be retrieved from a plurality of interfaces, each interface in the plurality being customized to interact with a different website. For example, in the plurality of interfaces, a game controller interface can be customized to interact and work in conjunction with a game website, while a slideshow remote interface can be customized to interact with a slideshow presentation website, and so forth. The retrieved first interface can be customized to interact with the first website and can be automatically presented on the mobile device, at step 510.

Continuing to step 512, the example method 500 can initiate one or more inputs using the mobile device for interacting with the first website. For example, a user of the mobile device (who can also be a user of the external computing device) can provide/submit/initiate one or more inputs by using a touchscreen on the mobile device, using a button/switch on the mobile device, using a gyroscope and/or accelerometer on the mobile device to detect user movements (e.g., determine a change in the orientation/rotation of the mobile device, recognize a gesture/motion, etc.), using a camera to detect/recognize image data, using a microphone to obtain sound data, and using other capabilities of the mobile device, etc.

Step 514 includes communicating with the paired web browser via the established connection with the network server to dynamically manipulate data associated with the first website based at least in part upon utilizing the one or more inputs initiated using the mobile device. For example, pressing a button on a game controller interface of the mobile device can, in real-time, cause a video game character to move within a game website rendered by the paired web browser on the external computing device.

In some embodiments, the method embodiment can optionally further include receiving, from the paired web browser, one or more instructions for dynamically manipulating data associated with the mobile device (e.g., data about a website rendered on the mobile device, data about an interface presented on the mobile device, data about an app on the mobile device, etc.). For example, prior to, during, and/or after (the app on) the mobile device dynamically manipulates data associated with the first website, the paired web browser rendering the first website can optionally provide one or more instructions for dynamically manipulating data associated with the mobile device. For example, in response to having the paired web browser's data (e.g., data about the rendered first website) dynamically manipulated by the app on the mobile device, the paired web browser can dynamically manipulate data associated with the app on the mobile device.

In some embodiments, the dynamic manipulation of data (including providing instructions for dynamic manipulation of data) can occur in real-time. For example, when the user submits/enters/initiates input via the mobile device, the external computing device can provide a response immediately. As such, the present disclosure allows the mobile device to operate/control (the application running on) the external computing device effectively.

In some embodiments, the interface(s) (e.g., graphical user interface(s), etc.) presented on the mobile device can enable one or more inputs to be initiated using the mobile device. For example, the interface can provide buttons for the user to submit input. In some embodiments, the interface can be dynamically manipulated by one or more instructions from the application on the external computing device.

Furthermore, various embodiments consistent with the present disclosure can be implemented for pairing among one or more mobile devices (e.g., one or more apps of the one or more mobile devices) and multiple external computing devices (e.g., one or more applications of each of the multiple external computing devices). For example, an app on a mobile device can be paired with multiple applications (e.g., different browsers) of an external computing device. In another example, an app on a mobile device can be paired with an application on a first external device and with an application on a second external device. In a further example, two apps, each on a separate mobile device, can be paired with one application on an external device. Again, the various examples presented in this disclosure should be taken as being illustrative in nature and not limiting to the scope of the disclosure.

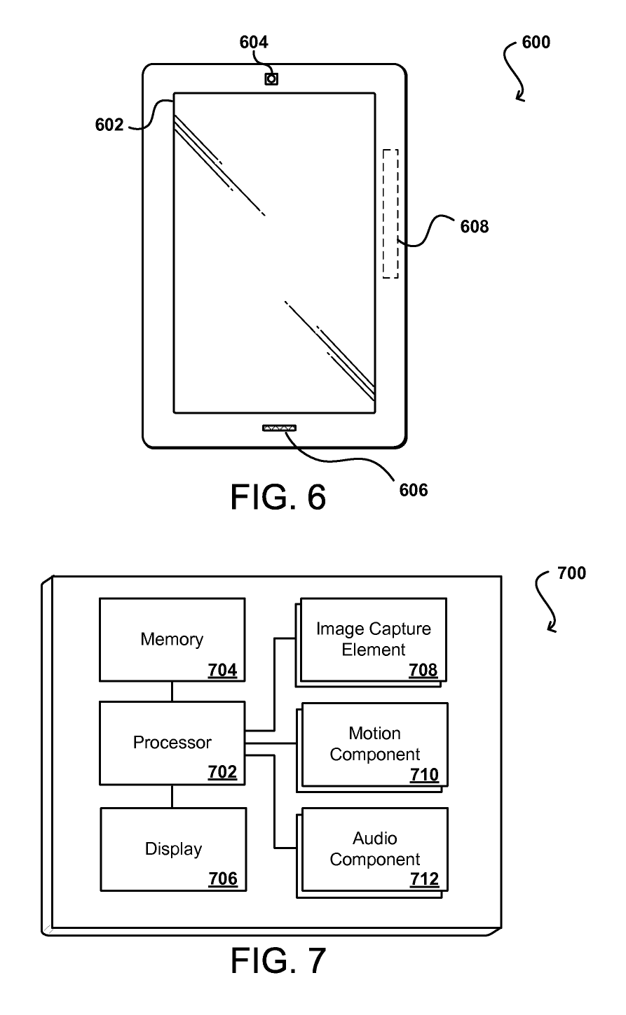

FIG. 6 illustrates an example electronic user device 600 that can be used in accordance with various embodiments. Although a portable/mobile computing device (e.g., an electronic book reader or tablet computer) is shown, it should be understood that any electronic device capable of receiving, determining, and/or processing input can be used in accordance with various embodiments discussed herein, where the devices can include, for example, desktop computers, notebook computers, personal data assistants, smart phones, video gaming consoles, television set top boxes, and portable media players. In some embodiments, the computing device can include home appliances with processing/computing power, such as a microwave oven with computing power, a toaster oven with computing power, a refrigerator with computing power, a stove/oven with computing power, a dishwasher with computing power, a washing machine/dryer with computing power, etc. In this example, the computing device 600 has a display screen 602 on the front side, which under normal operation will display information to a user facing the display screen (e.g., on the same side of the computing device as the display screen). The computing device in this example includes at least one camera 604 or other imaging element for capturing still or video image information over at least a field of view of the at least one camera. In some embodiments, the computing device might only contain one imaging element, and in other embodiments the computing device might contain several imaging elements. Each image capture element may be, for example, a camera, a charge-coupled device (CCD), a motion detection sensor, or an infrared sensor, among many other possibilities. If there are multiple image capture elements on the computing device, the image capture elements may be of different types. In some embodiments, at least one imaging element can include at least one wide-angle optical element, such as a fish eye lens, that enables the camera to capture images over a wide range of angles, such as 180 degrees or more. Further, each image capture element can comprise a digital still camera, configured to capture subsequent frames in rapid succession, or a video camera able to capture streaming video.

The example computing device 600 also includes at least one microphone 606 or other audio capture device capable of capturing audio data, such as words or commands spoken by a user of the device. In this example, a microphone 606 is placed on the same side of the device as the display screen 602, such that the microphone will typically be better able to capture words spoken by a user of the device. In at least some embodiments, a microphone can be a directional microphone that captures sound information from substantially directly in front of the microphone, and picks up only a limited amount of sound from other directions. It should be understood that a microphone might be located on any appropriate surface of any region, face, or edge of the device in different embodiments, and that multiple microphones can be used for audio recording and filtering purposes, etc.

The example computing device 600 also includes at least one orientation sensor 608, such as a position and/or movement-determining element. Such a sensor can include, for example, an accelerometer or gyroscope operable to detect an orientation and/or change in orientation of the computing device, as well as small movements of the device. An orientation sensor also can include an electronic or digital compass, which can indicate a direction (e.g., north or south) in which the device is determined to be pointing (e.g., with respect to a primary axis or other such aspect). An orientation sensor also can include or comprise a global positioning system (GPS) or similar positioning element operable to determine relative coordinates for a position of the computing device, as well as information about relatively large movements of the device. Various embodiments can include one or more such elements in any appropriate combination. As should be understood, the algorithms or mechanisms used for determining relative position, orientation, and/or movement can depend at least in part upon the selection of elements available to the device.

FIG. 7 illustrates a logical arrangement of a set of general components of an example computing device 700 such as the device 600 described with respect to FIG. 6. In this example, the device includes a processor 702 for executing instructions that can be stored in a memory device or element 704. As would be apparent to one of ordinary skill in the art, the device can include many types of memory, data storage, or non-transitory computer-readable storage media, such as a first data storage for program instructions for execution by the processor 702, a separate storage for images or data, a removable memory for sharing information with other devices, etc. The device typically will include some type of display element 706, such as a touch screen or liquid crystal display (LCD), although devices such as portable media players might convey information via other means, such as through audio speakers. As discussed, the device in many embodiments will include at least one image capture element 708 such as a camera or infrared sensor that is able to image projected images or other objects in the vicinity of the device. Methods for capturing images or video using a camera element with a computing device are well known in the art and will not be discussed herein in detail. It should be understood that image capture can be performed using a single image, multiple images, periodic imaging, continuous image capturing, image streaming, etc. Further, a device can include the ability to start and/or stop image capture, such as when receiving a command from a user, application, or other device. The example device similarly includes at least one audio capture component 712, such as a mono or stereo microphone or microphone array, operable to capture audio information from at least one primary direction. A microphone can be a uni- or omni-directional microphone as known for such devices.

In some embodiments, the computing device 700 of FIG. 7 can include one or more communication elements (not shown), such as a Wi-Fi, Bluetooth, RF, wired, or wireless communication system. The device in many embodiments can communicate with a network, such as the Internet, and may be able to communicate with other such devices. In some embodiments the device can include at least one additional input device able to receive conventional input from a user. This conventional input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device.

The device 700 also can include at least one orientation or motion sensor 710. As discussed, such a sensor can include an accelerometer or gyroscope operable to detect an orientation and/or change in orientation, or an electronic or digital compass, which can indicate a direction in which the device is determined to be facing. The mechanism(s) also (or alternatively) can include or comprise a global positioning system (GPS) or similar positioning element operable to determine relative coordinates for a position of the computing device, as well as information about relatively large movements of the device. The device can include other elements as well, such as may enable location determinations through triangulation or another such approach. These mechanisms can communicate with the processor 702, whereby the device can perform any of a number of actions described or suggested herein.

As an example, a computing device such as that described with respect to FIG. 6 can capture and/or track various information for a user over time. This information can include any appropriate information, such as location, actions (e.g., sending a message or creating a document), user behavior (e.g., how often a user performs a task, the amount of time a user spends on a task, the ways in which a user navigates through an interface, etc.), user preferences (e.g., how a user likes to receive information), open applications, submitted requests, received calls, and the like. As discussed above, the information can be stored in such a way that the information is linked or otherwise associated whereby a user can access the information using any appropriate dimension or group of dimensions.

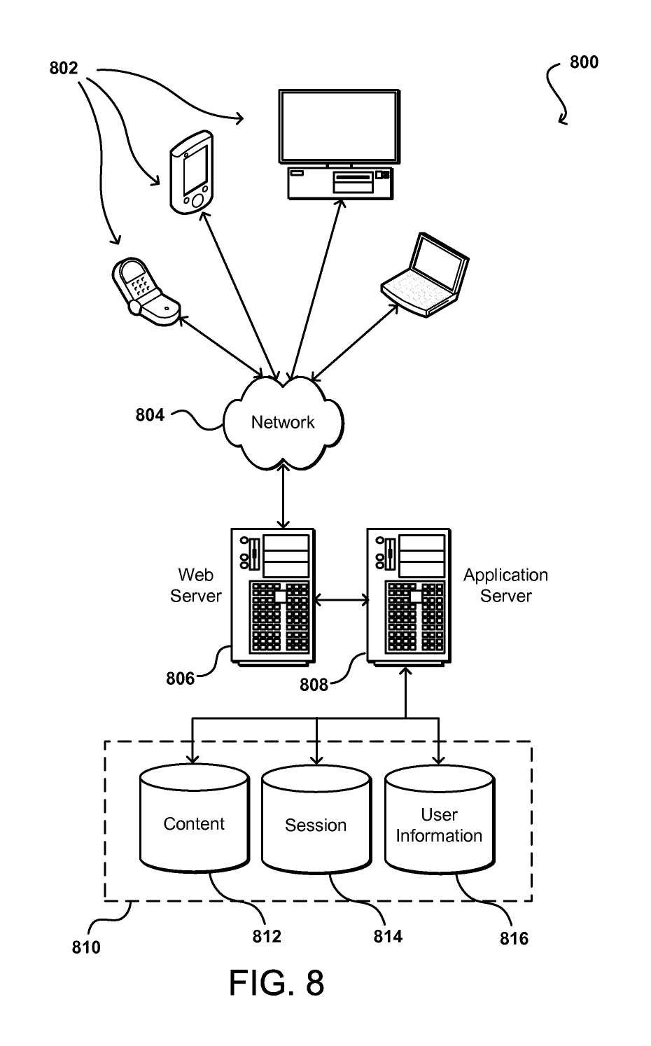

As discussed, different approaches can be implemented in various environments in accordance with the described embodiments. For example, FIG. 8 illustrates an example of an environment 800 for implementing aspects in accordance with various embodiments. As will be appreciated, although a Web-based environment is used for purposes of explanation, different environments may be used, as appropriate, to implement various embodiments. The system includes an electronic client device 802, which can include any appropriate device operable to send and receive requests, messages or information over an appropriate network 804 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 806 for receiving requests and serving content in response thereto, although for other networks an alternative device serving a similar purpose could be used, as would be apparent to one of ordinary skill in the art.

The illustrative environment includes at least one application server 808 and a data store 810. It should be understood that there can be several application servers, layers or other elements, processes or components, which may be chained or otherwise configured, which can interact to perform tasks such as obtaining data from an appropriate data store. As used herein the term “data store” refers to any device or combination of devices capable of storing, accessing and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server in the form of HTML, XML or another appropriate structured language in this example. The handling of all requests and responses, as well as the delivery of content between the client device 802 and the application server 808, can be handled by the Web server 806. It should be understood that the Web and application servers are not required and are merely example components, as structured code discussed herein can be executed on any appropriate device or host machine as discussed elsewhere herein.

The data store 810 can include several separate data tables, databases or other data storage mechanisms and media for storing data relating to a particular aspect. For example, the data store illustrated includes mechanisms for storing production data 812 and user information 816, which can be used to serve content for the production side. The data store also is shown to include a mechanism for storing log or session data 814. It should be understood that there can be many other aspects that may need to be stored in the data store, such as page image information and access rights information, which can be stored in any of the above listed mechanisms as appropriate or in additional mechanisms in the data store 810. The data store 810 is operable, through logic associated therewith, to receive instructions from the application server 808 and obtain, update or otherwise process data in response thereto. In one example, a user might submit a search request for a certain type of element. In this case, the data store might access the user information to verify the identity of the user and can access the catalog detail information to obtain information about elements of that type. The information can then be returned to the user, such as in a results listing on a Web page that the user is able to view via a browser on the user device 802. Information for a particular element of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 8. Thus, the depiction of the system 800 in FIG. 8 should be taken as being illustrative in nature and not limiting to the scope of the disclosure.

As discussed above, the various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computer-implemented method comprising:
establishing a connection on a mobile device for communicating with a network server;
pairing the mobile device with a web browser running on a computing device external to the mobile device if the mobile device and the web browser have been previously unpaired, wherein the web browser is communicatively connected to the network server;
receiving an instruction from the paired web browser to retrieve a first interface for interacting with a first website rendered by the paired web browser, wherein the first interface is retrieved from a plurality of interfaces, each interface in the plurality being customized to interact with a different website;
automatically presenting the retrieved first interface on the mobile device, wherein the first interface is customized to interact with the first website;
initiating one or more inputs using the mobile device for interacting with the first website; and
communicating with the paired web browser via the established connection with the network server to dynamically manipulate data associated with the first website based at least in part upon utilizing the one or more inputs initiated using the mobile device.

2. The computer-implemented method of claim 1, further comprising:
receiving, from the paired web browser, one or more instructions for dynamically manipulating data associated with the mobile device.

3. The computer-implemented method of claim 2, wherein the data associated with the mobile device includes data about the retrieved first interface on the mobile device.

4. The computer-implemented method of claim 1, further comprising:
receiving an instruction from the paired web browser to retrieve a second interface for interacting with a second website rendered by the paired web browser in response to the paired web browser being used to navigate to the second website, wherein the second interface is retrieved from the plurality of interfaces;
automatically presenting the retrieved second interface on the mobile device, wherein the second interface is customized to interact with the second website;
initiating one or more inputs using the mobile device for interacting with the second website; and
communicating with the paired web browser via the established connection with the network server to dynamically manipulate data associated with the second website based at least in part upon utilizing the one or more inputs initiated using the mobile device for interacting with the second website.

5. The computer-implemented method of claim 1, wherein the instruction received from the paired web browser is transmitted by the paired web browser in response to at least one of an initial navigation to the first website using the paired web browser or an initiation of an add-on installed for the paired web browser.

6. The computer-implemented method of claim 1, wherein the first interface is customized to interact with the first website by a developer of the first website.

7. The computer-implemented method of claim 1, wherein the plurality of interfaces is hosted on at least one of the network server, a website server, or a mobile server.

8. The computer-implemented method of claim 1, wherein the pairing of the mobile device with the web browser is based at least in part upon using the mobile device to read a machine-readable code presented by the web browser.

9. The computer-implemented method of claim 8, wherein the machine-readable code comprises at least one of a QR code, a Microsoft TAG, a matrix bar code, a wireless near-field communication signal, a RFID signal, a Bluetooth signal, a short-range wireless signal, a uniquely identifiable image, a uniquely identifiable biometric code, or an audio tag.

10. The computer-implemented method of claim 1, wherein the one or more inputs is initiated using at least one of a touch sensor, a microphone, a camera, an accelerometer, a gyroscope, a button, a key, or a switch on the mobile device.

11. The computer-implemented method of claim 1, wherein the communicating with the paired web browser via the established connection with the network server to dynamically manipulate data associated with the paired web browser is associated with at least one of a remote control operation, a slideshow presentation operation, a game operation, a character input operation, a pointer input operation, or a dual display operation.

12. A system comprising:
a computing device configured to execute a first web-connected application;
a mobile device external to the computing device configured to:
establish a pairing with the first web-connected application if the mobile device and the first web-connected application have been previously unpaired;
retrieve a first interface from a plurality of interfaces in response to an instruction from the first web-connected application, wherein each interface in the plurality is customized to interact with a different web-connected application; and
present the retrieved first interface, wherein the first interface is customized to interact with the first web-connected application;
a network server configured to communicate among the mobile device and the first web-connected application executing on the computing device;
at least one processor; and
a memory device including instructions that, when executed by the at least one processor, cause the system to:
dynamically manipulate data associated with the first web-connected application, wherein the manipulation of the data is based at least in part upon one or more instructions from at least one of the mobile device or the network server; and
dynamically manipulate the first interface presented on the mobile device, wherein the manipulation of the first interface is based at least in part upon one or more instructions from at least one of the first web-connected application or the network server.

13. The system of claim 12, further comprising:
a website server configured to host a website rendered by the first web-connected application.

14. The system of claim 12, further comprising:
a mobile server configured to provide data to be utilized by the retrieved first interface presented on the mobile device.

15. The system of claim 12, wherein the retrieved first interface presented on the mobile device is included in an app executing on the mobile device.

16. The system of claim 15, wherein the app executing on the mobile device is a web browsing app and the retrieved first interface presented on the mobile device includes at least a portion of a website rendered by the web browsing app.

17. The system of claim 16, wherein the website rendered by the web browsing app executing on the mobile device is a mobile version website associated with the website rendered in the first web-connected application executing on the computing device.

18. A non-transitory computer-readable storage medium including instructions for identifying elements, the instructions when executed by a processor of a mobile device causing the mobile device to:
establish a connection for communicating with a network server;
pair with a first web-connected application running on a computing device external to the mobile device if the mobile device and the first web-connected application have been previously unpaired, wherein the first web-connected application is communicatively connected to the network server;
receive an instruction from the first paired web-connected application to retrieve a first interface for interacting with the first paired web-connected application, wherein the first interface is retrieved from a plurality of interfaces, each interface in the plurality being customized to interact with a different web-connected application;
automatically present the retrieved first interface, wherein the first interface is customized to interact with the first paired web-connected application;
initiate one or more inputs for interacting with the first paired web-connected application; and
communicate with the first paired web-connected application via the established connection with the network server to dynamically manipulate data associated with the first paired web-connected application based at least in part upon utilizing the one or more inputs.

19. The non-transitory computer-readable storage medium of claim 18, wherein the instructions cause the mobile device to further receive, from the first paired web-connected application, one or more instructions for dynamically manipulating data associated with the mobile device.

20. The non-transitory computer-readable storage medium of claim 18, wherein the communicating with the first paired web-connected application via the established connection with the network server to dynamically manipulate data associated with the first paired web-connected application is associated with at least one of a remote control operation, a slideshow presentation operation, a game operation, a character input operation, a pointer input operation, or a dual display operation.
